(19) United States
(12) Patent Application Publication
(10) Pub. No.: US 2008/0090055 A1
(43) Pub. Date: Apr. 17, 2008

(54) MULTILAYER ACRYLIC RESIN FILM

(75) Inventor: Yousuke TSUKUDA, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/869,027

(22) Filed: Oct. 9, 2007

(30) Foreign Application Priority Data
Oct. 11, 2006 (JP) 2006-277263

(51) Int. Cl. B32B 3/10

(52) U.S. Cl. 428/195.1

(57) ABSTRACT

A multilayer acrylic resin film having two surface layers made of an acrylic resin composition consisting of from 20 to 100% by weight of a methacrylic resin and from 0 to 80% by weight of acrylic rubber particles which contains a UV absorber in an amount of 0.2 part by weight or less per 100 parts by weight of the acrylic resin composition, and at least one intermediate layer made of an acrylic resin composition consisting of from 20 to 100% by weight of a methacrylic resin and from 0 to 80% by weight of acrylic rubber particles which contains a UV absorber in an amount of at least 0.3 part by weight per 100 parts by weight of the acrylic resin composition.

### FIELD OF THE INVENTION

The present invention relates to a multilayer acrylic resin film having a UV absorbing property. The present invention also relates to a laminated molded article comprising a multilayer acrylic resin film.

### DESCRIPTION OF BACKGROUND ART

Molded resin articles produced by injection molding are widely used as interiors of automobiles and exteriors of household appliances. For decorating those molded resin articles, for example, a simultaneous injection molding-laminating method is employed. Examples of the simultaneous injection molding-laminating method include: a method comprising the steps of inserting a decorated resin film into an injection mold without pre-forming the film, injecting a molten resin into the mold, and laminating the decorated resin film on a molded resin article simultaneously with forming the molded resin article by injection molding; a method comprising the steps of inserting a decorated resin film into an injection mold after pre-forming the film by vacuum forming or air-pressure forming, injecting a molten resin into the die, and laminating the decorated film onto the molded resin article simultaneously with forming the molded resin article by injection molding; and a method comprising the steps of pre-forming a decorated resin film in an injection mold by vacuum forming or air-pressure forming, injecting a molten resin in the die, and laminating the decorated film on the molded resin article simultaneously with forming the molded resin article by injection molding. These simultaneous injection molding-laminating methods are disclosed in JP-B-63-6339, JP-B-4-9647 and JP-A-7-9484.

Meanwhile, to decorate a film, a method for applying designs, characters, etc. on the film by printing and a method for providing metallic gloss to the film by forming a thin film of a metal or an metal oxide by vacuum deposition are used. An acrylic resin film is preferably used in the simultaneous injection molding-laminating method described above, since it has excellent weather resistance while it has good surface gloss, surface hardness and surface smoothness.

The UV absorbing property of the acrylic resin film that serves as a surface layer is important for the laminated molded article formed by the simultaneous injection molding-laminating method to prevent a decoration layer formed on the lower surface of the film from degradation by UV rays. Accordingly, an acrylic resin film containing a UV absorber is advantageously used, but it may cause the contamination of facilities or the worsening of working environments, or it suffers from the decrease of the UV absorbing property, due to the evaporation or bleeding of the UV absorber during the film-forming process or shaping process or by changes over time. To solve those problems, JP-A-8-323934 and JP-A-10-45854 propose the use of a high molecular weight UV absorber, but the effects of such a UV absorber are not always satisfactory.

### SUMMARY OF THE INVENTION

An object of the present invention is to provide an acrylic resin film which can effectively suppress the evaporation or bleeding of a UV absorber contained in the film.

As the result of intensive studies by the inventors, it has been found that the above object can be achieved by forming a multilayer acrylic resin film comprising at least three layers using specific acrylic resin compositions such that the both surface layers do not contain any UV absorber or they contain, if any, a smaller amount of a UV absorber, while an intermediate layer contains a larger amount of a UV absorber.

Accordingly, the present invention provides a multilayer acrylic resin film comprising two surface layers made of an acrylic resin composition consisting of from 20 to 100% by weight of a methacrylic resin and from 0 to 80% by weight of acrylic rubber particles which contains a UV absorber in an amount of 0.2 part by weight or less per 100 parts by weight of the acrylic resin composition, and at least one intermediate layer made of an acrylic resin composition consisting of from 20 to 100% by weight of a methacrylic resin and from 0 to 80% by weight of acrylic rubber particles which contains a UV absorber in an amount of at least 0.3 part by weight per 100 parts by weight of the acrylic resin composition.

Furthermore, the present invention provides a laminated molded article comprising a molded resin article and the multilayer acrylic resin film of the present invention laminated on and integrated with at least a part of the molded resin article.

The multilayer acrylic resin film of the present invention can effectively prevent the evaporation or bleeding of the UV absorber contained therein, and the laminated molded article can be advantageously produced using the multilayer acrylic resin film of the present invention.

### DETAILED DESCRIPTION OF THE INVENTION

The acrylic resin film of the present invention is a multilayer acrylic resin film having at least three layers including two surface layers and at least one intermediate layer.

The acrylic resin composition constituting the surface layers or the intermediate layer consists of from 20 to 100% by weight of a methacrylic resin and from 0 to 80% by weight of acrylic rubber particles. The acrylic resin composition contains the acrylic rubber particles from the viewpoint of impact resistance and film-forming properties. The amount of the acrylic rubber particles is usually at least 5% by weight, preferably at least 10% by weight, and more preferably at least 20% by weight of the acrylic resin composition. However, since the surface hardness and solvent resistance of the film decrease if the content of the acrylic rubber particles is too high, the content thereof is usually 80% by weight or less, preferably 50% by weight or less, more preferably 40% by weight or less of the acrylic resin composition. The compositions of the acrylic resin compositions constituting the two surface layers and the intermediate layer(s) may be the same or different from one another.

The methacrylic resin is a polymer comprising a methacrylate ester as a principal monomer component, and may be a homopolymer of the methacrylate ester or a copolymer containing at least 50% by weight of the methacrylate ester and 50% by weight or less of at least one other monomer. The methacrylic resin preferably comprises from 50 to 100% by weight of an alkyl methacrylate, from 0 to 50% by weight of an alkyl acrylate and from 0 to 49% by weight of the other monomer.

Examples of the alkyl methacrylate include those having 1 to about 4 carbon atoms in an alkyl group such as methyl methacrylate, ethyl methacrylate and butyl methacrylate. Among them, methyl methacrylate is preferable. Examples of the alkyl acrylate include those having 1 to about 8 carbon atoms in an alkyl group such as methyl acrylate, ethyl acrylate, butyl acrylate and 2-ethylhexyl acrylate. The monomer other than the alkyl methacrylate and alkyl acrylate may be a compound having at least one polymerizable carbon-carbon double bond in the molecule, and examples of the other monomer include aromatic vinyl compounds such as styrene and vinyl cyanogen compounds such as acrylonitrile.

The acrylic rubber particles are particles comprising an elastic polymer comprising an acrylate ester as a principal monomer component. The rubber particle may have a monolayer structure essentially made of the elastic polymer, or may have a multilayer structure containing the elastic polymer as one layer. The elastic polymer may be a homopolymer of the acrylate ester, or a copolymer comprising at least 50% by weight of the acrylate ester and 50% by weight or less of at least one other monomer. The preferable monomeric composition of the elastic polymer is from 50 to 99.9% by weight of the alkyl acrylate, from 0 to 49.9% by weight of a monofunctional monomer other than the alkyl acrylate and from 0.1 to 10% by weight of a polyfunctional monomer.

Examples of the alkyl acrylate include those having 1 to 8 carbon atoms, preferably 4 to 8 carbon atoms in an alkyl group such as methyl acrylate, ethyl acrylate, butyl acrylate and 2-ethylhexyl acrylate. The monofunctional monomer other than the alkyl acrylate is a compound having one polymerizable carbon-carbon double bond in the molecule, and examples thereof include methacrylate esters such as methyl methacrylate, aromatic vinyl compounds such as styrene, and vinyl cyanogen compounds such as acrylonitrile. The polyfunctional monomer is a crosslinkable compound having at least two polymerizable carbon-carbon double bonds in the molecule, and examples thereof include (meth)acrylates of polyhydric alcohols such as ethyleneglycol di(meth)acrylate and butanediol di(meth)acrylate; alkenyl esters of (meth)acrylic acid such as allyl(meth)acrylate and methallyl(meth)acrylate; and divinylbenzene. Herein, (meth)acrylate refers to methacrylate or acrylate, and (meth)acrylic acid refers to methacrylic acid or acrylic acid.

In the case of acrylic rubber particles having a multilayer structure, an example of the acrylic rubber particles having a dual layer structure includes particles having an inner layer of an elastic polymer comprising an acrylate ester and an outer layer of a polymer comprising a methacrylate ester. An example of the acrylic rubber particles having a triple layer structure includes particles having an innermost layer of a polymer comprising a methacrylate ester, an intermediate layer of an elastic polymer comprising an acrylate ester, and an outermost layer of a polymer comprising a methacrylate ester. The acrylic rubber particles having the multilayer may be produced, for example, by the method described in JP-B-55-27576. The acrylic rubber particles described in Example 3 of JP-B-55-27576 have one of preferable compositions as the acrylic rubber particles having a triple layer structure.

The acrylic rubber particles having a monolayer or dual layer structure may preferably be used from the viewpoint of the flexibility of the film and the film-forming property, while the acrylic rubber particles having a multilayer structure of at least three layer structure may be preferably used from the viewpoint of the surface hardness of the film. One kind of the acrylic rubber particles may be used, or two or more kinds of the acrylic rubber particles may be used in combination.

When the acrylic rubber particles having the monolayer structure or dual layer structure are used, the average particle size of the rubber particles is preferably at least 10 nm, more preferably at least 30 nm, from the viewpoint of the impact resistance of the film, while the average particle size of the rubber particles is preferably 150 nm or less, more preferably 80 nm or less, from the viewpoint of the transparency and laminating property of the film. When the rubber particles having the multilayer structure of at least three layers are used, the average particle size of the rubber particles is preferably at least 100 nm from the viewpoint of the impact resistance of the film, while the average particle size is preferably 400 nm or less, more preferably 300 nm or less, from the viewpoint of the transparency of the film.

The average particle size of the acrylic rubber particles may be set to a preferable value by selecting the kind and amount of a polymerization initiator, and/or by adjusting polymerization conditions such as a polymerization time. The average particle size of the acrylic rubber particles used in the present invention can be measured as follows:

A film is formed by mixing rubber particles with a methacrylic resin, the rubber component is stained with ruthenium oxide on the cross section of the film, and the diameters of the stained portions are measured with an electron microscope and averaged. When the rubber particles having the elastic polymer layer comprising the acrylate ester are mixed with the methacrylic resin and the cross section of the mixture is stained with ruthenium oxide, the methacrylic resin as a matrix is not stained. In addition, an outer layer containing a polymer comprising the methacrylate ester present around the elastic polymer layer is not stained either. Thus, only the elastic polymer layer is stained. Accordingly, the average particle size of the rubber particles is determined from the diameters of the portions that are observed as substantially a circular shape with the electron microscope. However, when a polymer comprising the methacrylate ester is present inside the elastic polymer layer, the polymer in the inner layer is not stained, and the cross section is observed as a dual layer structure in which the elastic polymer layer present outside of the inner layer polymer is stained. In this case, the average particle size of the rubber particle may be calculated based on the outside diameter of the dual layer structure, that is, the outer diameter of the elastic polymer layer.

On one hand, the amount of the UV absorber contained in the two surface layers is desirably 0.2 part by weight or less, preferably 0.1 part by weight or less per 100 parts by weight of the acrylic resin composition, and more preferably the UV absorber is not contained at all, in order to suppress the evaporation or bleeding of the UV absorber during the film-forming process or the shaping process, or by changes over time. The amounts of the UV absorber in the both surface layers may be the same or different from one another. On the other hand, the amount of the UV absorber contained in the intermediate layer is desirably at least 0.3 part by weight, preferably at least 0.4 part by weight and more preferably at least 0.5 part by weight per 100 parts by weight of the acrylic resin composition from the viewpoint of enhancing the UV absorbing property. However, when the content of the UV absorber is too large, it is difficult to completely dissolve the UV absorber in the acrylic resin compositions, resulting in the decrease of the transparency and strength of the film, and also resulting in the increase of the production cost. Accordingly, the amount of the UV absorber is usually 5 parts by weight or less, preferably 3 parts by weight or less.

Specific examples of the UV absorber contained in the surface layers and the intermediate layer include benzotriazole UV absorbers such as 2,2′-methylenebis[4-(1,1,3,3-tetramethylbutyl)-6-(2H-benzotriazol-2-yl)phenol], 2-(2-hydroxy-5-methylphenyl)-2H-benzotriazole, 2-[2-hydroxy-3,5-bis(α,α-dimethylbenzyl)phenyl]-2H-benzotriazole, 2-(3,5-di-tert-butyl-2-hydroxyphenyl)-2H-benzotriazole, 2-(3-tert-butyl-5-methyl-2-hydroxyphenyl)-5-chloro-2H-benzotriazole, 2-(3,5-di-tert-butyl-2-hydroxyphenyl)-5-chloro-2H-benzotriazole, 2-(3,5-di-tert-amyl-2-hydroxyphenyl)-2H-benzotriazole and 2-(2′-hydroxy-5′-tert-octylphenyl)-2H-benzotriazole; 2-hydroxybenzophenone UV absorbers such as 2-hydroxy-4-methoxybenzophenone, 2-hydroxy-4-octyloxybenzophenone, 2,4-dihydroxybenzophenone, 2-hydroxy-4-methoxy-4′-chlorobenzophenone, 2,2′-dihydroxy-4-methoxybenzophenone and 2,2′-dihydroxy-4,4′-dimethoxybenzophenone; salicylic acid phenyl ester UV absorbers such as p-tert-butylphenyl salicylate and p-octylphenyl salicylate; and the like. A plurality of them may be optionally used. The kinds of the UV absorbers contained in the both surface layers and the intermediate layer may be the same or different from one another.

The multilayer acrylic resin film of the present invention preferably has a UV absorbing property such that a light transmittance at a wavelength of 380 nm in the thickness direction of the film is 15% or less, in order to protect the film itself from yellowing caused by weathering and to prevent underlying designs and the substrate resin from degradation by weathering. The light transmittance of the film is preferably 10% or less, more preferably 5% or less, when the long term weather resistance of the film is required. The light transmittance of the film is desirably 2% or less for attaining the UV absorbing property necessary for outdoor uses where the film is irradiated by strong sunlight. The present invention advantageously provides the multilayer acrylic resin film with which the evaporation or bleeding of the UV absorber is suppressed while such a high UV absorbing property is satisfied.

Conventional additives, for example, organic dyes and pigments, inorganic pigments, antioxidants, antistatic agents and surfactants may be added to the acrylic resins constituting the surface layers and intermediate layer.

The multilayer acrylic resin film is produced by forming a film so as to have the requisite layers using the acrylic resin composition and the UV absorber as described above. The thickness of each surface layer is usually from 5 to 200 μm, the thickness of the intermediate layer is usually from 5 to 400 μm, and the total thickness the multilayer film is usually from 50 to 500 μm. The thickness of one of the surface layer may be the same as or different from that of the other.

If the thickness of the surface layer is too small, the UV absorber contained in the intermediate layer may readily migrate to the surfaces of the multilayer film across the surface layers, and thus the contamination of the rolls during the film-forming process and the contamination of the mold during the molding process as well as the bleeding of the UV absorber onto the surfaces of the multilayer film during the long term storage tend to occur. Accordingly, the thickness of each surface layer is usually at least 5 μm, preferably at least 10 μm. Since a larger thickness of the intermediate layer is advantageous for facilitating the mixing work for adding a higher concentration of the UV absorber, the thickness of the intermediate layer is usually at least 5 μm, preferably at least 20 μm and more preferably at least 50 μm. While the total thickness of the film is usually 500 μm or less as described above, it is preferably 300 μm or less when the film is used for the simultaneous injection molding-laminating method in the mold from the viewpoint of the shaping property.

To produce the multilayer acrylic resin film of the present invention, a suitable method may be selected from various conventional methods such as a method using a feed block and a method using a multi-manifold die. A preferable method for producing a film having a good surface state comprises the steps of laminating surface layer materials and an intermediate layer material with inserting a feed block therebetween by extruding the molten resins through a T-die to form a multilayer film; and allowing at least one surface of the laminated film obtained to contact with a roll or a belt. It is preferable to allow the both surfaces of the laminated film produced by the above method to contact with rolls or belts from the viewpoint of the improvement of the surface smoothness and the surface gloss of the film. The surface of the roll or belt is preferably mirror-finished for making the film surface smooth.

The multilayer acrylic resin film of the present invention is usually colorless and transparent, and has a total light transmittance of at least 60%, preferably at least 80%, when measured according to JIS K7015.

The multilayer acrylic resin film of the present invention may be favorably used as a laminating film adhered to various molded articles, for example interiors of automobiles, exteriors of household appliances and transparent substrates of display members. At least one surface of the film may be decorated by, for example, forming designs by printing or by providing metallic gloss with the formation of a thin film of a metal or a metal oxide by vacuum deposition. The simultaneous injection molding-laminating method is advantageously used for laminating the film on the molded resin article.

Examples of the simultaneous injection molding-laminating method include a method comprising the steps of inserting the film into an injection mold without pre-forming, injecting a molten resin into the mold, and forming an injection molded resin article while simultaneously laminating the film on the injection molded resin article (which is referred to as a simultaneous injection molding-laminating method in a narrow sense); a method comprising the steps of injecting the film into the injection mold after pre-forming the film by vacuum forming or air-pressure forming, injecting a molten resin into the mold, and forming an injection molded resin article while simultaneously laminating the film on the injection molded resin article (which is referred to as an insert molding method); and a method comprising the steps of pre-forming a film in an injection mold by vacuum forming or air-pressure forming, injecting a molten resin into the mold, and forming an injection molded resin article while simultaneously laminating the film on the injection molded resin article (which is referred to as an in-mold molding method).

The laminated molded resin article thus obtained can maintain light fastness for a long period of time without causing any troubles, since the laminated acrylic resin film, which effectively suppresses the evaporation or bleeding of the UV absorber contained therein, is integrated with the molded resin article.

### EXAMPLES

The present invention will be illustrated by the following Example, which do not limit the scope of the present invention. In the Examples, “%” and “pars” representing contents or amounts of materials or components used are “% by weight” and “parts by weight”, respectively, unless otherwise stated.

The pellets of a thermoplastic resin (glass transition temperature: 104° C.) obtained by polymerizing methyl methacrylate and a small amount of methyl acrylate were used as a methacrylic resin.

Acrylic rubber particles produced according to Example 3 of JP-B-55-27576 were used. They had a spherical three-layer structure consisting of an innermost layer made of a rigid polymer prepared by polymerizing methyl methacrylate and a small amount of allyl methacrylate, an intermediate layer made of an elastic polymer prepared by polymerizing butyl acrylate as a major component with styrene and a small amount of allyl methacrylate, and an outermost layer made of a rigid polymer prepared by polymerizing methyl methacrylate and a small amount methyl acrylate. The average particle size of the particles was 0.22 μm.

UV absorber (A) was 2-(2-hydroxy-5-methylphenyl)-2H-benzotriazole (SUMISORB 200, manufactured by Sumika Chemtex Co., Ltd.).

UV absorber (B) was 2,2′-methylenebis[4-(1,1,3,3-tetramethylbutyl)-6-(2H-benzotriazol-2-yl)phenol] (trade name: ADEKATAB La-31, manufactured by Adeka Corporation).

### Example 1

After mixing 80 parts of the methacrylic resin pellets, 20 parts of the acrylic rubber particles and 0.1 part of UV absorber (A) with a Super Mixer, the mixture was melted and kneaded with a twin screw extruder at a cylinder temperature of 240° C. to obtain pellets of the resin composition, which were used as a surface layer material.

After mixing 80 parts of the methacrylic resin pellets, 20 parts of the acrylic rubber particles and 0.9 parts of UV absorber (B) with a Super Mixer, the mixture was melted and kneaded with a twin screw extruder at a cylinder temperature of 240° C. to obtain pellets of the resin composition, which were used as an intermediate layer material.

The surface layer material and intermediate layer material obtained above were charged to a single screw extruder with a diameter of 65 mm (manufactured by Toshiba Machine Co., Ltd.) and a single screw extruder with a diameter of 45 mm (manufactured by Toshiba Machine Co., Ltd.), respectively, to melt them. Then, the materials were extruded by a feed block method through a T-die at a die temperature of 275° C., so that the surface layer material was disposed on the both surfaces of the intermediate layer material, and the laminate was cooled by allowing one surface thereof to contact with a polishing roll to obtain a multilayer film. The rotation speeds of the extruders were controlled so that the thickness of each surface layer was 20 μm, the thickness of the intermediate layer was 85 μm, and the thickness of the whole multilayer film was 125 μm.

The presence of contaminations on the polishing roll caused by the bleeding of the UV absorber was visually observed during the preparation of the multilayer film. The result is shown in Table 1.

The total light transmittance of the multilayer film obtained was measured according to JIS K7105. The result is shown in Table 1.

The light transmittance of the multilayer film was measured with a spectrophotometer (UV3100PC manufactured by Shimadzu Corporation) in a wavelength range from 200 to 800 nm. The light transmittance at a wavelength of 380 nm is shown in Table 1.

The multilayer film obtained was subjected to an accelerated weather resistance test using an EYE SUPER UV tester (manufactured by Iwasaki Electric Co., Ltd.) by irradiating UV rays (70 mW/cm²) for 48 hours. An yellowing index (YI) before and after the test was measured according to JIS K7105, and the difference ΔYI (YI after test−YI before test) is shown in Table 1.

### Example 2

After mixing 80 parts of the methacrylic resin pellets and 20 parts of acrylic resin particles with a Super Mixer without adding any UV absorber, the mixture was melted and kneaded with a twin screw extruder at a cylinder temperature of 240° C. to obtain the pellets of the resin composition, which was used as a surface layer material.

After mixing 80 parts of the methacrylic resin pellets, 20 parts of acrylic resin particles and 2.0 parts of UV absorber (B) with a Super Mixer, the mixture was melted and kneaded with a twin screw extruder at a cylinder temperature of 240° C. to obtain the pellets of the resin composition, which was used as an intermediate layer material.

The surface layer material and intermediate layer material obtained above were charged to a single screw extruder with a diameter of 65 mm (manufactured by Toshiba Machine Co., Ltd.) and a single screw extruder with a diameter of 45 mm (manufactured by Toshiba Machine Co., Ltd.), respectively, to melt them. Then, the materials were extruded by the feed block method through a T-die at a die temperature of 275° C. so that a three layer structure in which the surface layer materials were disposed on the both surfaces of the intermediate layer material was formed, and then the laminate was cooled by allowing one surface thereof to contact with a polishing roll to obtain a multilayer film. The rotation speeds of the extruders were controlled so that the thickness of each of the surface layers was 10 μm, the thickness of the intermediate layer was 105 μm and the total thickness of the multilayer film was 125 μm. The multilayer film thus obtained was evaluated by the same methods as those in Example 1. The results are shown in Table 1.

### Comparative Example 1

After mixing 80 parts of the methacrylic resin pellets, 20 parts of the acrylic rubber particles and 0.5 part of UV absorber (B) with a Super Mixer, the mixture was melted and kneaded with a twin screw extruder at a cylinder temperature of 240° C. to obtain the pellets of the resin composition.

The pellets obtained above were melted with a single axis extruder (manufactured by Toshiba Machine Co., Ltd.) and extruded through a T-die at a die temperature of 275° C., followed by cooling the film by allowing one surface of the film to contact with a polishing roll to obtain a single layer film. In this case, the rotation speed of the extruder was controlled so that the thickness of the film was 125 μm. The single layer film obtained was evaluated by the same methods as those in Example 1. The results are shown in Table 1.

TABLE 1

| | Surface layer/Intermediate | | | | | | |
|---|---|---|---|---|---|---|---|
| | layer/Surface layer | | | | | | |
| | UV | UV | | | Total light | | |
| | absorber | absorber | Thickness | Contamination | transmittance | Transmittance | |
| Example | (kinds) | (parts) | (μm) | of rolls | (%) | at 380 nm (%) | ΔYI |
| Example 1 | (A)/(B)/(A) | 0.1/0.9/0.1 | 20/85/20 | None | 92 | 11 | 1.8 |
| Example 2 | —/(A)/— | —/2.0/— | 10/105/10 | None | 92 | 7 | 1.5 |
| Comparative | (B) | 0.5 | 125 | Present | 92 | 13 | 2.0 |
| Example 1 | | | | | | | |

What is claimed is:

1. A multilayer acrylic resin film comprising:
two surface layers made of an acrylic resin composition consisting of from 20 to 100% by weight of a methacrylic resin and from 0 to 80% by weight of acrylic rubber particles which contains a UV absorber in an amount of 0.2 part by weight or less per 100 parts by weight of the acrylic resin composition, and
at least one intermediate layer made of an acrylic resin composition consisting of from 20 to 100% by weight of a methacrylic resin and from 0 to 80% by weight of acrylic rubber particles which contains a UV absorber in an amount of at least 0.3 part by weight per 100 parts by weight of the acrylic resin composition.

2. The multilayer acrylic resin film according to claim 1, wherein a light transmittance at a wavelength of 380 nm in the thickness direction of the film is 15% or less.

3. The multilayer acrylic resin film according to claim 1, wherein a thickness of each of the surface layers is at least 10 μm.

4. The multilayer acrylic resin film according to claim 1, which has a total thickness of at least 300 μm.

5. The multilayer acrylic resin film according to claim 1, wherein the surface layers contain no UV absorber.

6. The multilayer acrylic resin film according to claim 1, wherein the acrylic resin composition constituting the surface layers contains 20 to 95% by weight of the methacrylic resin and 5 to 80% by weight of the acrylic rubber particles.

7. The multilayer acrylic resin film according to claim 1, wherein the acrylic resin composition constituting the intermediate layer contains 20 to 95% by weight of the methacrylic resin and 5 to 80% by weight of the acrylic rubber particles.

8. The multilayer acrylic resin film according to claim 1, wherein the methacrylic resin is a polymer prepared by polymerizing 50 to 100% by weight of an alkyl methacrylate, 0 to 50% by weight of an alkyl acrylate and 0 to 49% by weight of at least one other monomer.

9. The multilayer acrylic resin film according to claim 1, wherein the acrylic rubber particles contain an elastic polymer prepared by polymerizing 50 to 99.9% by weight of an alkyl acrylate, 0 to 49.9% by weight of a monofunctional monomer other than the alkyl acrylate and 0.1 to 10% by weight of a polyfunctional monomer.

10. The multilayer acrylic resin film according to claim 1, wherein at least one of the surfaces of the film is decorated.

11. A laminated molded resin article comprising a molded resin article and a multilayer acrylic resin film according to claim 1 laminated on at least a part of the molded resin article.
